(19) United States
(12) Patent Application Publication
(10) Pub. No.: US 2016/0098740 A1
(43) Pub. Date: Apr. 7, 2016

(54) METHOD AND SYSTEM FOR USING A SIGNAL UNIVERSAL PRODUCT CODE (UPC) TO START DISCOUNT INJECTION

(71) Applicant: Outsite Networks, Inc., Norfolk, VA (US)

(72) Inventors: Anton Bakker, Norfolk, VA (US); Marc L. Allen, Virginia Beach, VA (US)

(21) Appl. No.: 14/505,672

(22) Filed: Oct. 3, 2014

(51) Int. Cl. G06Q 30/02; G06Q 20/20

(52) U.S. Cl. CPC G06Q 30/0222; G06Q 30/0238; G06Q 20/208

(57) ABSTRACT

A system, method, and computer program for using and detecting a signaling Universal Product Code (UPC), including a discount or marketing system; a UPC sniffer or injector; and a signal UPC configured to represent an end of a Point of Sale (POS) transaction. The UPC sniffer or injector configured to receive UPCs scanned from a POS UPC scanner and transmit the received UPCs to the discount or marketing system; the discount or marketing system configured to receive the UPCs from the UPC sniffer or injector, and to recognize the UPC as the signal UPC representing the end of the transaction, and issuing pending UPC injections; and the UPC sniffer or injector configured to receive UPC injections and to send the UPC injections to a POS system for inclusion in the transaction.

### BACKGROUND OF THE INVENTION

1. Field of the Invention

The present invention generally relates discount processing systems and methods, and more particularly to systems and methods adding of incentives and discounts to purchase transactions based on a Universal Product Code (UPC).

2. Discussion of the Background

Manufacturers, retailers, and other third-parties would like to be able to offer incentives and discounts to their customers, but are often unable to broadly offer them across a set of locations due to large differences in retail systems located at those sites. Each site may have a different brand of Point of Sale (POS) unit as well as a different back-office system for handling inventory and promotions.

Parties interested in offering incentives and discounts across such a wide spectrum of locations and equipment have started turning toward third-party programs which are equipment agnostic. Typically, these programs rely on obtaining transaction information as the transaction occurs, but suffer from an inability to know when it is safe to add a discount to a transaction such that the Point of Sale (POS) will honor it. Once a transaction has completed, it is no longer possible to modify it with incentives or discounts.

### SUMMARY OF THE INVENTION

Therefore, there is a need to provide a system and method that addresses the above and other problems with discount processing systems and methods. Accordingly, in an illustrative embodiment a system and method are configured to provide a safe-to-inject signal based on a Universal Product Code (UPC) to a Point of Sale (POS) system. Advantageously, an employed discounting system then knows exactly when the POS is prepared to accept an injected UPC, so as to provide a proper discount at the proper time.

Accordingly, in illustrative aspects of the present invention there is provided a system, method and computer program product for using and detecting a signaling Universal Product Code (UPC), including a discount or marketing system; a UPC sniffer or injector; and a signal UPC configured to represent an end of a Point of Sale (POS) transaction. The UPC sniffer or injector configured to receive UPCs scanned from a POS UPC scanner and transmit the received UPCs to the discount or marketing system; the discount or marketing system configured to receive the UPCs from the UPC sniffer or injector, and to recognize the UPC as the signal UPC representing the end of the transaction, and issuing pending UPC injections; and the UPC sniffer or injector configured to receive UPC injections and to send the UPC injections to a POS system for inclusion in the transaction.

The system, method and computer program product are configured to filter out or block the signal UPC from being received by the POS system.

The signal UPC is configured to represent one of specific or general age verification being concluded successfully or unsuccessfully, age range of the consumer, gender of the consumer, inclusion or exclusion of the consumer from a predefined group as configured in the discount or marketing system.

The signal UPC is configured to represent a combination of the represented signals.

The discount or marketing system is configured to employ the signal UPC in determining discount injections issued.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an illustrative system wherein a signal Universal Product Code (UPC) is used to obtain discounts and incentives at a proper time in a Point of Sale (POS) system; and

FIG. 2 is an illustrative flowchart showing how the system of FIG. 1 operates from a view of a cashier and customer, when a specific signal UPC indicating an end of a transaction is employed in a Point of Sale (POS) system.

### DETAILED DESCRIPTION OF THE PREFERRED EMBODIMENTS

The present invention includes recognition that typically, current third-party programs obtain transaction information from monitoring a barcode scanner or possibly a live security camera feed that provides information as it happens. These programs may also use either a same port as the barcode scanner or possibly an auxiliary port to inject discount and incentive information into a transaction. All this is being done without Point of Sale (POS) equipment being aware of it. Unfortunately, as the POS equipment is unaware of the third-party actions, it is not always in the proper state to accept a barcode or other discount information. For example, the POS unit might be performing an Age Verification or other confirmation process that is requiring a manual entry from the cashier. While this process is occurring, the POS unit has likely disabled any inputs that would allow for discount or incentive injections. Should a system attempt to inject a barcode or some other input, that injection would fail and most likely not be detected by the system. Accordingly, the disclosed system and method is configured to provide a safe-to-inject signal based on a Universal Product Code (UPC) to a POS system, and can include a button pressed by the cashier or a barcode scanned at the appropriate time, and the like.

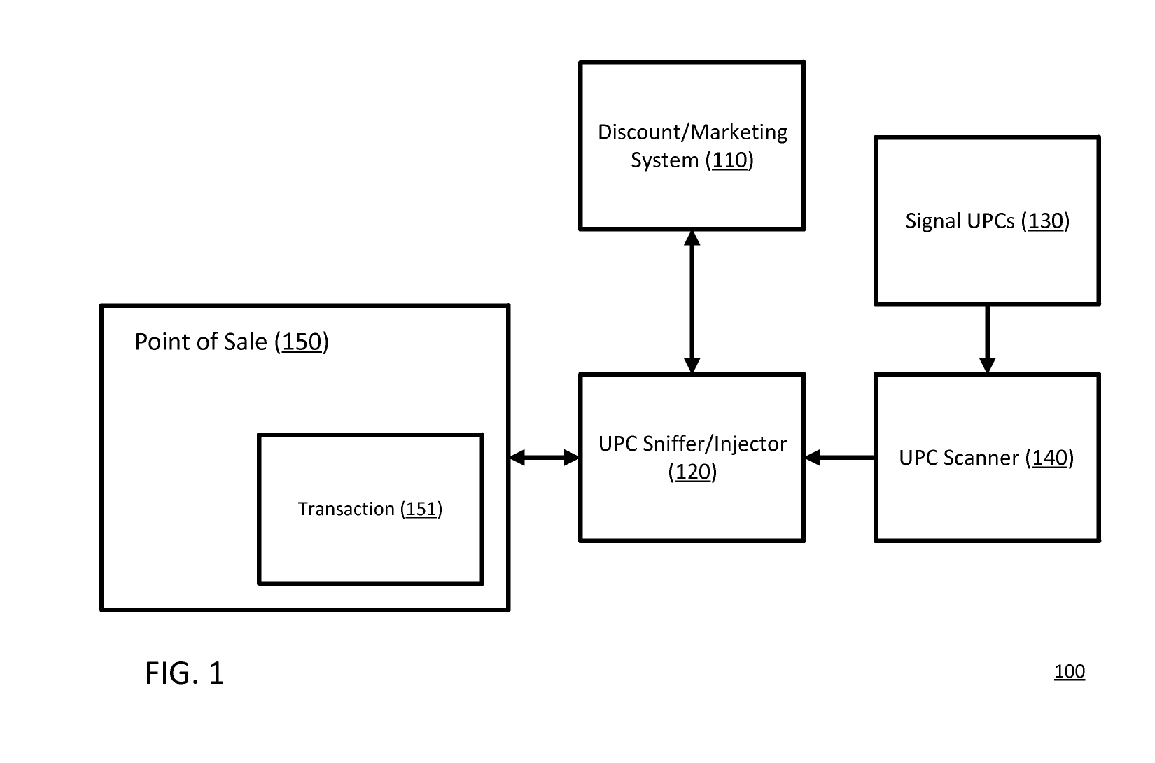

Referring now to the drawings and more particular to FIG. 1 thereof, there is illustrated a safe-to-inject system 100 utilizing illustrative equipment from a retail location. The system 100 includes a Discount or marketing System 110 that is illustrated as a single item for simplicity, but can include multiple components with some at the physical location and some at a remote location and with appropriate communications technologies to allow the components to act together as a whole.

The system 100 also includes a UPC Sniffer or Injector 120 that is illustrated as being between the UPC or barcode Scanner 140 and the Point of Sale 150 for simplicity, but can also be designed such that it passively monitors communications with an ability to override the communications channel to insert its own UPC data. Additionally, the UPC Sniffer or Injector can include independent components for sniffing and for injecting, particularly if the Point of Sale 150 allows additional input or output channels. The UPC Sniffer or Injector 110 receives UPC information sent to the Point of Sale 150 and sends it to the Discount or marketing System 110. The UPC Sniffer or Injector 110 also receives discount UPC codes from the Discount or marketing System 110 and sends them to the Point of Sale 150 in a manner such that the Point of Sale 150 can incorporate the discount into the Transactions 151.

The system 100 also includes an one or more Signal UPCs 130 that the cashier uses at the UPC Scanner 140 during the Transaction 151 to indicate one or more readiness states. The Signal UPCs 130 are sent to the Discount or marketing System 110 via the UPC Sniffer or Injector 120 as normal, and the Discount or marketing System 110 is able to make the appropriate discounts knowing that the Point of Sale 150 is not only ready to accept barcode (e.g., a UPC, etc.) injections, but also that all suitable items have been entered into the Transaction 151.

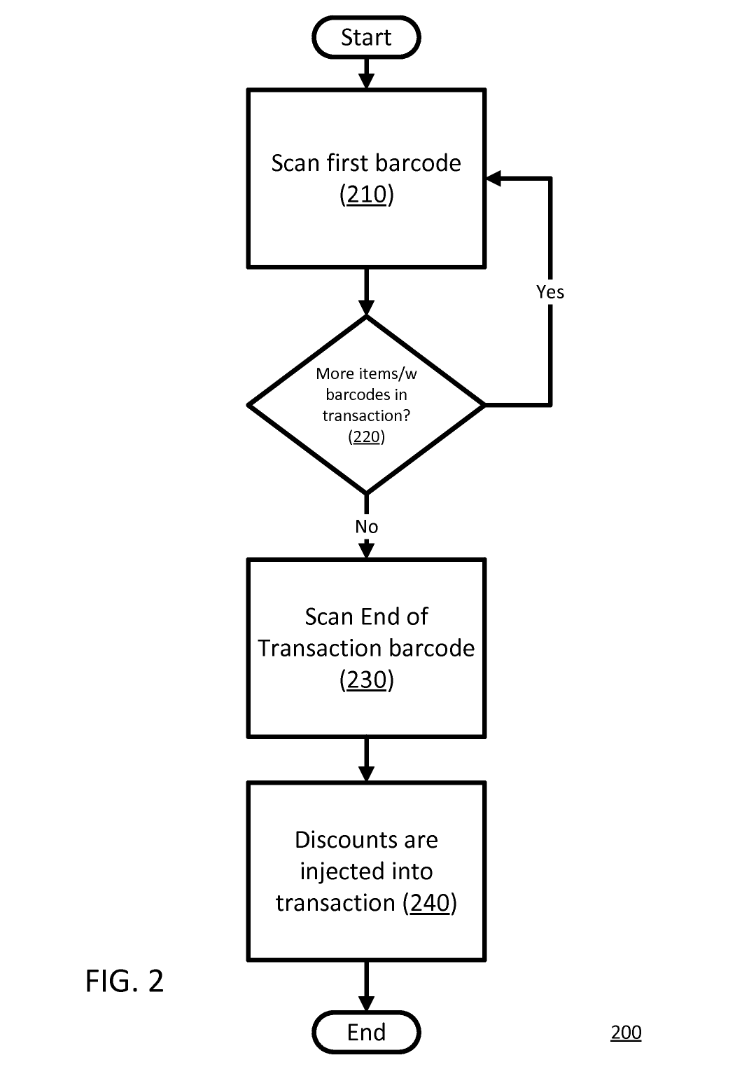

FIG. 2 is an illustrative flowchart showing how the process appears to operate for the cashier and customer. The cashier scans the initial barcode in step 210. Then, in step 220, step 210 is repeated until no other barcodes are left to scan for the transaction. Once no other barcodes are available, the cashier scans the Signal UPC 130 that indicates End of Transaction in step 230. At that point, the Discount or marketing System 110 can inject any and all suitable valid discounts during step 240.

The Signal UPCs 130 can either be blocked from the Point of Sale 110 by the UPC Sniffer or Injector 120 or the Point of Sale 110 can be programmed to accept that barcode as a costless ($0.00) item and enter it into the transaction. If neither of these options are feasible, it can be set up as a low-cost item (e.g. $0.10) which is then compensated for with an additional discount (e.g. −$0.10) from the Discount or marketing System 110.

Although the present invention is described in terms of using barcodes in conjunction with a UPC Sniffer or Injector, it can work equally well with any other suitable source of transaction input (e.g. RFID, keyboard entry, and the like). Similarly, the Signal UPCs 130 can be any suitable signaling system which can be detected and/or transmitted to the Discount or marketing System 110 (e.g. a button, biometric ID, time delay, and the like).

Using a Signal UPC 130 does not necessarily prohibit the Discount or marketing System 110 from injecting discounts or incentives at any suitable time. Certain Point of Sale 110 configurations can provide additional information to the Discount or marketing System 110 allowing it to make more informed decisions.

The set of signals employed by the Signal UPCs 130 can include an end of transaction, a specific or general age verification check being concluded successfully or unsuccessfully, information about the consumer (e.g., age range, gender, other predefined consumer groupings, and the like), and the like.

The Discount or marketing System 110 can also be configured with predefined consumer groupings that a consumer may or may not belong to (e.g., belonging to a particular church, attending a particular school, be a fan of a particular sports team, be a member of a club, be a high-frequency or high-value customer, and the like). Signal UPCs 130 can be used to identify the transaction consumer as part of or not part of one or more of these groups, and the like. Each of the Signal UPCs 130 can be defined as a combination of one or more of such meanings (e.g., both male and age verified; all of student, interested in football, and end of transaction; and the like).

The above-described devices and subsystems of the illustrative embodiments of FIGS. 1-2 can include, for example, any suitable servers, workstations, PCs, laptop computers, PDAs, Internet appliances, handheld devices, cellular telephones, wireless devices, other devices, and the like, capable of performing the processes of the illustrative embodiments of FIGS. 1-2. The devices and subsystems of the illustrative embodiments of FIGS. 1-2 can communicate with each other using any suitable protocol and can be implemented using one or more programmed computer systems or devices.

One or more interface mechanisms can be used with the illustrative embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like. Accordingly, the devices and subsystems of the illustrative embodiments can be implemented on the World Wide Web.

It is to be understood that the devices and subsystems of the illustrative embodiments of FIGS. 1-2 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-2 can be implemented via one or more programmed computer systems or devices.

To implement such variations as well as other variations, a single computer system can be programmed to perform the special purpose functions of one or more of the devices and subsystems of the illustrative embodiments of FIGS. 1-2. On the other hand, two or more programmed computer systems or devices can be substituted for any one of the devices and subsystems of the illustrative embodiments of FIGS. 1-2. Accordingly, principles and advantages of distributed processing, such as redundancy, replication, and the like, also can be implemented, as desired, to increase the robustness and performance the devices and subsystems of the illustrative embodiments of FIGS. 1-2.

The devices and subsystems of the illustrative embodiments of FIGS. 1-2 can store information relating to various processes described herein. This information can be stored in one or more memories, such as a hard disk, optical disk, magneto-optical disk, RAM, and the like, of the devices and subsystems of the illustrative embodiments of FIGS. 1-2. One or more databases of the devices and subsystems of the illustrative embodiments of FIGS. 1-2 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-2 can include appropriate data structures for storing data collected and/or generated by the processes of the devices and subsystems of the illustrative embodiments of FIGS. 1-2 in one or more databases thereof.

All or a portion of the devices and subsystems of the illustrative embodiments of FIGS. 1-2 can be conveniently implemented using one or more general purpose computer systems, microprocessors, digital signal processors, micro-controllers, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-2 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-2, for driving the devices and subsystems of the illustrative embodiments of FIGS. 1-2, for enabling the devices and subsystems of the illustrative embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-2. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A system for using and detecting a signaling Universal Product Code (UPC), the system comprising:
a discount or marketing system;
a UPC sniffer or injector;
a signal UPC configured to represent an end of a Point of Sale (POS) transaction;
the UPC sniffer or injector configured to receive UPCs scanned from a POS UPC scanner and transmit the received UPCs to the discount or marketing system;
the discount or marketing system configured to receive the UPCs from the UPC sniffer or injector, and to recognize the UPC as the signal UPC representing the end of the transaction, and issuing pending UPC injections; and
the UPC sniffer or injector configured to receive UPC injections and to send the UPC injections to a POS system for inclusion in the transaction.

2. The system of claim 1, wherein the system is configured to filter out or block the signal UPC from being received by the POS system.

3. The system of claim 1, wherein the signal UPC is configured to represent one of specific or general age verification being concluded successfully or unsuccessfully, age range of the consumer, gender of the consumer, inclusion or exclusion of the consumer from a predefined group as configured in the discount or marketing system.

4. The system of claim 3, wherein the signal UPC is configured to represent a combination of the represented signals.

5. The system of claim 1, wherein the discount or marketing system is configured to employ the signal UPC in determining discount injections issued.

6. A method for using and detecting a signaling Universal Product Code (UPC), the method comprising:
providing a discount or marketing system;
providing a UPC sniffer or injector;
providing a signal UPC configured to represent an end of a Point of Sale (POS) transaction;
receiving with the UPC sniffer or injector UPCs scanned from a POS UPC scanner and transmitting the received UPCs to the discount or marketing system;
receiving with the discount or marketing system the UPCs from the UPC sniffer or injector, and recognizing the UPC as the signal UPC representing the end of the transaction, and issuing pending UPC injections; and
receiving with the UPC sniffer or injector UPC injections and sending the UPC injections to a POS system for inclusion in the transaction.

7. The method of claim 6, further comprising filtering out or blocking the signal UPC from being received by the POS system.

8. The method of claim 6, further comprising representing with the signal UPC one of specific or general age verification being concluded successfully or unsuccessfully, age range of the consumer, gender of the consumer, inclusion or exclusion of the consumer from a predefined group as configured in the discount or marketing system.

9. The system of claim 8, wherein the signal UPC is configured to represent a combination of the represented signals.

10. The method of claim 6, further comprising the discount or marketing system employing the signal UPC in determining discount injections issued.

11. A computer program product for using and detecting a signaling Universal Product Code (UPC), and the method including one or more computer readable instructions embedded on tangible, non-transitory computer readable medium and configured to cause one or more computer processors to perform the steps of:
providing a discount or marketing system;
providing a UPC sniffer or injector;
providing a signal UPC configured to represent an end of a Point of Sale (POS) transaction;
receiving with the UPC sniffer or injector UPCs scanned from a POS UPC scanner and transmitting the received UPCs to the discount or marketing system;
receiving with the discount or marketing system the UPCs from the UPC sniffer or injector, and recognizing the UPC as the signal UPC representing the end of the transaction, and issuing pending UPC injections; and
receiving with the UPC sniffer or injector UPC injections and sending the UPC injections to a POS system for inclusion in the transaction.

12. The computer program product of claim 11, further comprising filtering out or blocking the signal UPC from being received by the POS system.

13. The computer program product of claim 11, further comprising representing with the signal UPC one of specific or general age verification being concluded successfully or unsuccessfully, age range of the consumer, gender of the consumer, inclusion or exclusion of the consumer from a predefined group as configured in the discount or marketing system.

14. The computer program product of claim 13, wherein the signal UPC is configured to represent a combination of the represented signals.

15. The computer program product of claim 11, further comprising the discount or marketing system employing the signal UPC in determining discount injections issued.
